(19) United States
(12) Patent Application Publication
(10) Pub. No.: US 2011/0040538 A1
(43) Pub. Date: Feb. 17, 2011

(54) METHOD FOR PREPARING MODELS

(75) Inventors: Nghia Dang Duc, Hildesheim (DE); Peter Engel, Hildesheim (DE); Gerrit De Boer, Hildesheim (DE); Sascha Goldner, Lugdstadt (DE)

Correspondence Address: MERCHANT & GOULD PC, P.O. BOX 2903, MINNEAPOLIS, MN, 55402-0903, US

(73) Assignee: Robert Bosch GMBH, Stuttgart (DE)

(21) Appl. No.: 12/739,522

(22) PCT Filed: Oct. 15, 2008
(86) PCT No.: PCT/EP2008/063823

§ 371 Date: Oct. 29, 2010

(30) Foreign Application Priority Data
Oct. 24, 2007 (DE) 10 2007 050 804.4

(51) Int. Cl. G06G 7/48

(52) U.S. Cl. 703/6

(57) ABSTRACT

The invention relates to a method for preparing models of technical devices, wherein each technical device comprises units that are connected to each other by means of connection points, wherein, when performing the method, at least one structure made of units connected to each other by means of connection points comprising similarities for all technical devices is integrated and automatically described as at least one mutual module (8) for all models.

The invention relates to a procedure for preparing models, a procedure for diagnosing at least one technical device, a device for preparing models, a computer program and a computer program product.

### STATE OF THE ART

The functionality is increasingly provided at modern motor vehicles by software. The spectrum ranges from the engine control to comfort systems; a data processor architecture that is based on this is construed as allocated system. Depending on the type of motor vehicle there are 20 to 80 control unit knots, which are connected to up to four different bus systems. A program code comprises thereby several hundred thousand up to several million lines. Such a connectivity in the motor vehicle will continuously increase in the following years, coming along with the increasing complexity of hydraulic, pneumatic and mechanic motor vehicle components as well as an increasing type variety of motor vehicles. For those reasons the troubleshooting and error correcting in the body shop is significantly complicated.

During the service in the body shop the considered diagnosing strategy is of a symptomatic nature, which means that an initial point for the body shop diagnosis is a certain number of symptoms of a malfunctioning, which usually originate from three diagnosis information sources:
Information, which originate from an online diagnosis from the control unit diagnosis
Information from physical measuring variables at an offline diagnosis, for example: voltage, pressure, exhaust gases and so on
Information from subjective observations of the body shop staff, for example noises, visual control.

Nowadays there are different diagnosis tools, which support the staff in the body shop during the troubleshooting. Advanced systems are based on algorithms of a class of the model-based diagnosis. Those algorithms analyze all available diagnosis information and compare them to a functional model of the motor vehicle. With the functional model the behavior of the motor vehicle is described up to a certain detail. The models are thereby usually construed hierarchically, which means there are models of components, which illustrate in their connectivity the model of a subsystem, several subsystems create models of system or braking system, engine system and so on, the number of all system models creates finally the model of the motor vehicle.

By comparing the actual behavior of a motor vehicle with the modeled behavior model-based diagnosis algorithms are able to provide recommendations for suspicious components or also additional measuring and checking instructions.

### DISCLOSURE OF THE INVENTION

The invention relates to a procedure for preparing models and thereby for modeling a number of technical devices, whereby it is provided that each technical device has units, which are connected with each other by connecting points, whereby at least one structure of units that are connected with each other by connection points is taken together during the implementation of the procedure, which provides similarities for all technical devices, and is automatically described as at least one mutual module for all models of the technical devices.

Therefore the at least one mutual module for all models and therefore the number of the technical devices is automatically described.

In one configuration the described similarities are extracted over the connection point or connection knot or even ports. Furthermore those similarities can be construed identically for all technical devices. Within one module the units provide internal connection points or ports, over which the units within the modules are connected with each other. External connection points or ports of the module or of units, which are especially arranged at a limit of the modules, are suited for creating connections to units outside of the module.

In another embodiment of the procedure it is provided that at least one structure, which provides at least one unit with at least one connection point, which is present for at least one technical device and which distinguishes itself from the at least one mutual module in its structure, is described as at least one variant of a model for the at least one technical device within the number of the technical devices, whereby at least one difference of the variant is extracted, so that overall similarities and variant-specific nuances or differences of the technical devices can be extracted.

The at least one mutual module is usually construed as maximum coherent mutual or identical structure for all devices. With the procedure and in particular with the models a behavior of the technical devices can be described. By providing mutual modules a behavior, which has a number or if necessary all technical devices immanent, for this number of the technical devices comprising and therefore for all those devices can be considered as similar. A behavior, which is only immanent in one device or only a few devices, can be described by units outside of mutual modules, so that those units describe special or specific variants of individual modules.

Among others it is provided that interactions between the units are described with the connecting points. Furthermore a hierarchy of the units is described in the course of the procedure. Thus for example units, which are arranged in a lowest component of technical devices, are summarized in an almost highest level as subsystems and such subsystems in a almost highest level as systems and systems only as models of technical devices. Mutual modules of several technical devices can summarize mutual structures, which can comprise the units, subsystems as well as systems.

In a variant of the invention at least one structure of units that are connected to each other over connecting points, which provides similarities for a partial number of the technical devices or is arranged identically, is automatically described as at least one module for the partial amount or as partial module of the technical devices.

The procedure serves for example for similar or related technical devices for example motor vehicles of one production series with different motorizations or features. By providing the mutual modules units are modeled all in all considering connecting points for all motor vehicles. Differences between the motor vehicles, which can depend among others on different features, are considered as variants in the scope of the procedure. Within the structures, which can be modeled as mutual or variant-specific modules, the connecting points mirror coherences between individual units within such structures. The described connecting points or knots are either described as internal or external ports. A first internal connecting point can thereby connect or link at a first unit within a structure and/or a module this first unit with a second unit, which provides a second connecting point. So-called external ports or connecting points are usually construed module-overlapping and can connect a module with another module or another unit.

The similarities and if necessary the differences of the technical devices are extracted by the described establishment of structures and/or modules. The structures or modules comprise therefore groups of units.

At least one group of units, which provides one mutual or identical structure for all devices, can also be described all in all as one mutual abstract for the devices, whereby at least one unit, which distinguishes itself from the units of the at least one group, is described for at least one device as a variant in addition to the abstract. The abstract can therefore be described depending on a coherent structure of the units of the at least one group.

Also hierarchies of units of the technical devices can also be described with the models. It is thereby provided among others that individual components of technical devices are described as most simple and most elementary units. Depending on the structure individual components and therefore units can be summarized as modules, which are also called as so-called subsystems, depending on the way they are connected with each other over connecting points. Such subsystems can on the other hand be called units, which can furthermore be summarized as systems considering the connecting points, which also create mutual or if necessary different modules for the technical devices.

It is provided that the technical devices can be described modularly with the aid of the described procedure. Mutual or identical modules, which provide similarities for all technical device or at least a part of the technical devices or which are arranged identically, are called abstracts among others, with which a modular modulation of the technical devices is enabled, so that by a summarizing consideration of a number of technical devices, which are summarized as abstracts, a diagnosis of at least one technical device is possible at an application.

All technical devices can provide at least one group of mutual features, furthermore at least one of those devices can provide a feature that distinguishes itself from the mutual features or units, so that the at least one group of mutual features is described as one abstract, and at which the at least one different feature or different unit is described as variant in addition to the at least one abstract for the at least one device. Even two or more groups of mutual features or units are possible. Among others a metric for structure similarities of components is considered by the invention. The described variants can be based on the same foundations.

The invention furthermore relates to a procedure for diagnosing at least one technical device, which comprises several units and is assigned to a number of technical devices, whereby the diagnosis is carried out with the aid of a model for the at least one technical device, which is described by a procedure according to one of the previous claims.

Considering the prepared models also a summarizing consideration of all technical devices is thereby possible, because the now present similarities can be considered for all devices altogether over the mutual modules.

The device according to the invention for preparing models of technical devices, whereby it is provided, that each technical device provides units, which are connected with each other over connecting points, is construed to automatically describe at least one structure of units that are connected with each other by connecting points, which provides similarities for all technical devices, as at least one mutual module for all technical devices.

This described device according to the invention is also construed to carry out all steps of at least one of the previous procedures, which means the procedure for preparing the models of the technical device as well as the procedure for diagnosing at least one technical device.

The computer program with program code means is construed to implement all steps of a described procedure, if the computer program is carried out on a computer or a corresponding arithmetic unit, in particular in a described device.

The invention furthermore relates to a computer program product with program code means, which are stored on a computer-readable date carrier, in order to carry out all steps of a suggested procedure, if the computer program is carried out on a computer or a corresponding arithmetic unit, in particular in a device according to the invention.

Furthermore modulation mechanisms are provided by the invention, in order to be able to face the given variant variety of the invention efficiently, and to enable a simple connection of already existing models by using mutual modules, in order to set the basis for a system-overlapping diagnosis.

Therefore typical aspects for a modulation language are provided by the invention. During an application the invention can be used for implementing a model-based diagnosis for at least one technical device.

Usually all models underlie a hierarchic structure, whereby components are summarized as smallest units in subsystems or modules as biggest units. Within the systems, which can be also construed as modules, subsystems are again summarized.

Considering the variety of variants it is possible with the aid of the invention to extract similarities of technical devices and therefore of models with the modulation mechanisms, in order to create thereby automatically modules or so-called abstracts. An abstract s typically a module, which provides only the similarities of several technical devices, for example a basic structure of a diesel system for a motor vehicle type of a series, which applies for all variants. An abstract can therefore serve as template for a number of variants. This results in the fact that by using an abstract for all variants or technical devices as concretes already one part of the model is present and that only the variant-specific nuances are models as additional units and therefore concreted, for example a turbo charger at a diesel system with a turbo charger. A hierarchic order of the abstracts is also possible, which means abstracts, which provide again similarities themselves, can again be further abstracted and thereby summarized.

The modulation effort can be reduced by the invention. Furthermore a reusability of existing modules is provided, for example abstracts for variants or for systems that have to be developed new.

At a system-overlapping diagnosis an interconnection of partial systems of a modules or abstract is possible. Interfaces are for example the basis of the relay, which are called ports. Those special ports can be provided by the invention, in order to enable a function assignment as internal or external port.

Furthermore an interconnection of partial systems with each other, in particular also by connecting systems, can thereby be realized. In connection with the so-called black-box procedure of a used modulation language a system-overlapping diagnosis is enabled, without having to develop all components exactly, whereby for example only the external connecting points of subsystems or modules but not the units, which are summarized in such subsystems or modules, are considered in this context, like at a so-called black-box.

The black-box procedure is a common mechanism, which allows to model sub or partial systems, without making thereby detailed statements about the internal structure. Only the total behavior, for example if air of the amount A flows in, the air amount B must flow out, and the external ports of the sub or partial systems have to be known.

In an embodiment two problems can be treated with the invention, which occur during the creation of the models and therefore at the modulation. That is on the one hand the treatment of the variety of variants and on the other hand the possibility of the system-overlapping diagnosis.

There is a variety of different variants existing for one motor vehicle type in one embodiment. Diesel systems with different engine sizes, with and without a turbo charger and so one are for example present for one motor vehicle type of a specific production series. The basic structure however of those diesel systems is identical. If the model of each variant is now created separately, it means an enormous modulation effort. A further disadvantage is that a model of a special variant only applies to it and can only be used for it. With the invention modulation mechanisms can be described by generating the mutual modules or abstracts, which minimize this effort and enable a reusability. Furthermore a system-overlapping diagnosis can be implemented.

By providing the invention it is now also possible that model-based diagnosing tools support a system-overlapping diagnosis even if the systems are not modeled completely at the same detail degree. Furthermore a hierarchic structuring is realized at the modeling with the aid of the invention.

Therefore a limited calculation demand is required, so that it does not increase exponentially to the size of the model. Furthermore a modulation of the models is possible. A servicing of the models is also provided.

For preparing the modeling it is provided that the models are present in a modeling language. A modeled unit has basically in- and output, so-called ports. A relation between units is described by relations, behavior charts or equations with the aid of the modeling language. The relations in a model contain usually parameters, which can also be adjusted in the scope of the modeling. When interconnecting partial models, for example components or subsystems, the term of the materials prevails. Materials are transported between and also through components as simple units. Materials provide attributes, which characterize statuses of the materials and which can be changed as a module during the transport through the components or a subsystem. In one embodiment air is used as material, the related attributes are temperature, pressure and humidity. The interconnection of partial systems and the modeling of the materials take also place with the aid of the modeling language.

For treating the variety of variants abstract models are used. The abstract or modules can either be created automatically from existing models or manually. At an automatic abstraction process at least two models are required. The objective of an abstraction algorithm can be among others to detect similarities and differences in the models. The basis for this evaluation are previously specified metrics. One metric can for example evaluate the structure similarity of components, in which the number, position and the used material of the ports are examined. If two components correspond at all ports in all criteria this components can be taken over completely into the abstract model and therefore the mutual module or abstract. If differences occur at first only the similarities are taken over before subsequently the differences, which concretize the variants, are considered. Rules can here be also specified, which solve possible conflicts in the case of inequalities. Generally the metrics that are used at the comparison depend strongly on the field of application and are previously explicitly specified before an application.

Further advantages and embodiments of the invention arise from the description and the attached drawing.

It shall be understood that the previously mentioned and the following characteristics that have to be explained can be used not only in the stated combination but also in other combinations or alone, without having to leave the scope of the present invention.

### SHORT DESCRIPTION OF THE DRAWINGS

FIG. 1 schematically shows an illustration of an example for an abstraction process that is carried out in the scope of a first embodiment of the procedure.

FIG. 2 schematically shows an illustration of an example for a aggregation of partial systems over external ports that is carried out in the scope of a second embodiment of the procedure.

### EMBODIMENTS OF THE INVENTION

The invention is schematically illustrated with the aid of embodiments in the drawings and is exactly described in the following in reference to the drawings.

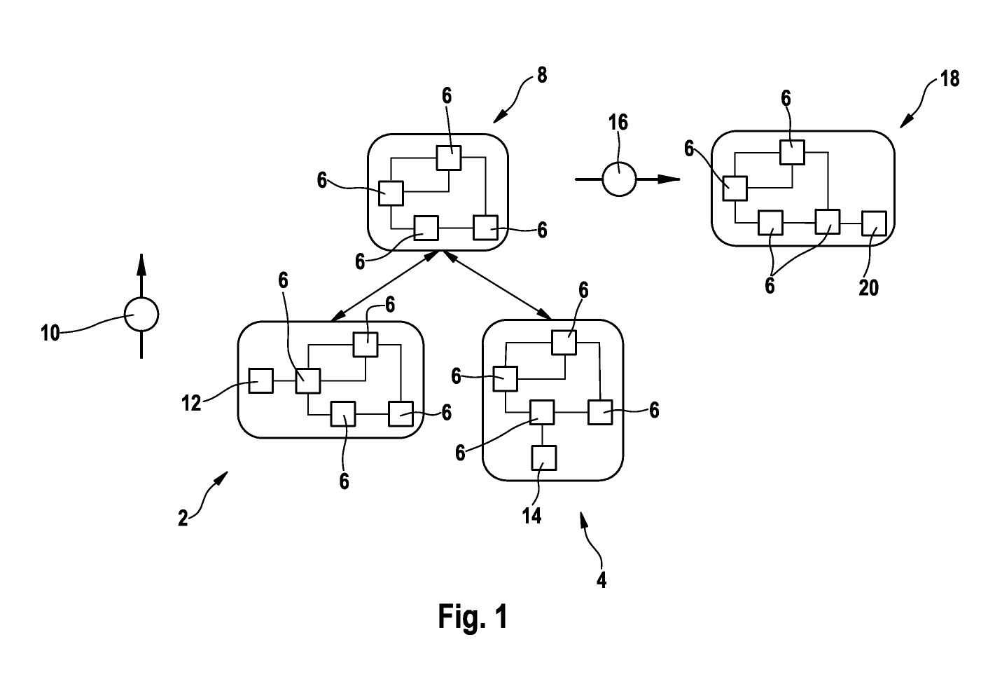

One aspect of an embodiment of the procedure according to the invention is schematically illustrated by FIG. 1. FIG. 1 shows thereby two subsystems 2, 4. Each of those two subsystems 2, 4 comprises first components 6, which are connected with each other over connecting points and therefore create a mutual structure due to an identical composition, which is extracted and therefore described as mutual module 8 in the scope of a first abstraction step 10. Furthermore it results from FIG. 1 that the first subsystem 2 provides a second component 12 and the second subsystem 4 provides a third component 14. Therefore the two subsystems 2, 4 have the units in common, which are construed and summarized within the mutual module 8 as first components 6. But the two subsystems 2, 4 differ from each other by the second and third component 12, 14.

It is possible in the scope of a second abstraction step 16 to create a new third subsystem 18 that is based on the mutual module 8. That third subsystem 18 comprises also the common module 8 with the first components 6 that are connected with each other over connecting points. But the third subsystem 18 distinguishes itself from the two first subsystems 2, 4 by an additional unit, which is connected with the module 8 over an additional connecting point and construed s fourth component 20.

Therefore FIG. 1 shows a simplified embodiment of an abstraction process in a schematic illustration. At first two subsystems 2, 4 are provided, which differ from each other only by one component 12, 14. The remaining components 6 are identical and can be taken over at a first abstraction step 10 into the mutual module 8 or abstract. The abstract provides therefore all similarities of the two subsystems 2, 4. If a third subsystem 18 shall be created, which provides at least the units of the abstract, the abstract in a second abstraction step 16 can be used as a template. Only the additionally concretizing features of the new subsystem 18 have to be still modeled. The abstraction depth underlies here no limitations, which means abstract and therefore mutual modules 8 can be abstracted again. This process can be continued as long as one likes.

The connecting points or ports can serve at a system-overlapping diagnosis for connecting components 6, 12, 14, 20, subsystems 2, 4, 18, systems 42 or also entire models with each other. It is thereby necessary to distinguish two different types of ports. Internal ports are in this context internal connecting points of components 6, 12, 14, 20 or elements within a module 8, subsystem 2, 4, 18 or system 42 and enable only connections of these internal elements with each other. The second type of connections are so-called external ports. They are exclusively connection point of a subsystem 2, 4, 18 with other external structures, usually systems, subsystems 2, 4, 18 or components 6, 12, 14, 20, they are usually the in- or outputs of the subsystems 2, 4, 18 and the key to a system-overlapping diagnosis. The basic requirement at an interconnection of subsystems 2, 4, 18 is the hierarchic structuring possibility of the modeling language.

The smallest unit at the modeling is a component 6, 12, 14, 20 and can only provide external ports or external connecting points. A connection of several components 6, 12, 14, 20 results in a subsystem 2, 4, 18 or a system, mutual structures that exist within such subsystems 2, 4, 18 or systems are summarized as mutual modules 8. As already mentioned, the interconnection can only be provided by external ports.

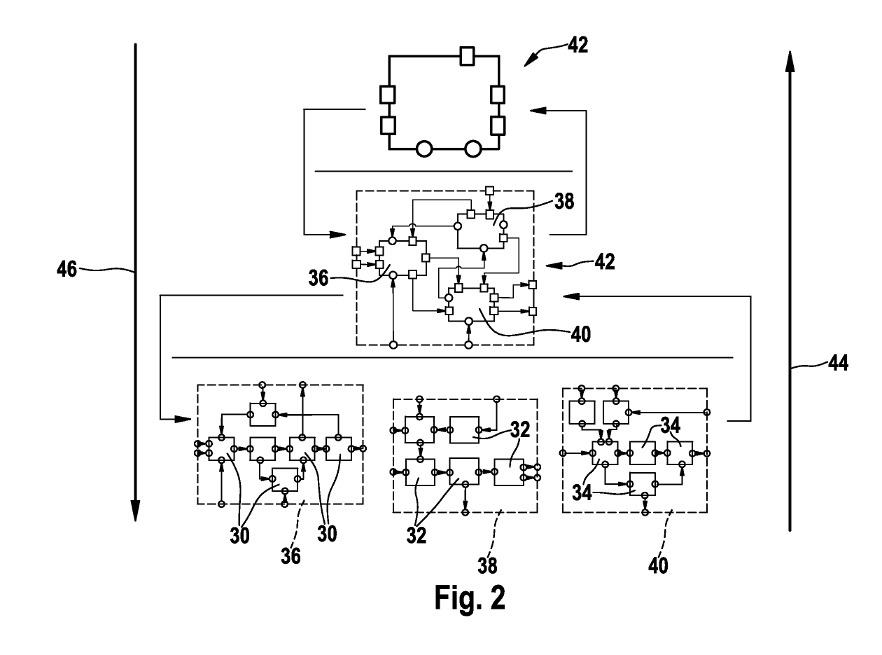

FIG. 2 shows in a schematic illustration an exemplary interconnection of components 30, 32, 34 to subsystems 36, 38, 40 and subsystems 36, 38, 40 to a system 42. Furthermore a hierarchic arrangement of the system 42, the subsystems 36, 38, 40 and the components 30, 32, 34 is shown.

A first subsystem 36 comprises thereby six components 30 as units, which are connected with each other within the subsystem 36 by internal connecting point or ports. The second subsystem comprises five units that are construed as components 32, which are also connected with each other over internal connecting points. Similarly the third subsystem 4 are shown in detail, the individual components 30, 32, 34 can be seen besides the internal connection points within the corresponding subsystem 36, 38, 400, which provides six units that are construed as component s34, is structured, whereby the components 34 of the third subsystem 40 are also connected with each other by internal connecting points.

In a lower plane of FIG. 2, in which the three subsystems 36, 38, 40 with their components 30, 32, 34 are shown in detail, also external connecting points or ports can be seen besides the internal connecting points, which connect the individual components 30, 32, 34 within the corresponding subsystems 36, 38, 40 with each other.

By summarizing the subsystems 36, 38, 40 the system 42 is created, whereby the subsystems 36, 38, 40 are connected with each over the external connecting points. The details of this system 42 are illustrated in a middle plane of FIG. 2, whereas the system 42 is shown in an upper section of FIG. 2 as compact unit with their own external connecting points.

The external ports can become internal ports at an interconnection of the next higher plane in the scope of an upwards or bottom-up consideration 44. This takes place for example at the interconnection of the three subsystems 36, 38, 40 to the system 42. The lowest, external port of the second subsystem in FIG. 2 in the lowest plane becomes an internal port in the middle plane after connecting to a system 42, so that the second subsystem 38 can be connected by these ports with the third subsystem 40. In the range of a downwards or top-down consideration details and therefore units of superior structures are clarified at a drop from a higher to a lower plane.

With the aid of an abstraction algorithm similarities can be extracted from existing model elements, for example the subsystems 36, 38, 40, in order to create an abstract. This abstract or mutual module can be used as template for new variants of variety of variants.

A system-overlapping diagnosis is thereby usually achieved, that the elements of a model provide internal and external ports and can only be connected with each other over external ports. It is thereby irrelevant how detailed the individual sun or partial systems are modeled, which shows a central difference to present approaches.

The abstraction process can be triggered manually in the modeling software by clicking on the corresponding system.

Internal and external ports can be illustrated in a modeling software by different colors.

1. Procedure for preparing models of technical devices, wherein it is provided, that each technical device has units, which are connected with each other over connecting points, whereby at least one structure of units that are connected with each other over connecting points, which provide similarities for all technical devices, are summarized and automatically described as at least one mutual module for all models at the implementation of the procedure.

2. Procedure according to claim 1, at which the similarities are extracted.

3. Procedure according to claim 1 wherein at least one structure, which has at least one unit with at least one connecting point, which is present for at least one technical device and which distinguishes itself from the at least one mutual module in its structure, is described as at least one variant of a model for the at least one technical device, whereby at least one difference of the variant is extracted.

4. Procedure according to claim 1, wherein a behavior of the technical devices is described.

5. Procedure according to claim 1, wherein interactions between units are described with the connecting points.

6. Procedure according to claim 1, wherein a hierarchy of the units is described.

7. Procedure according to claim 1, wherein at least one structure of units that are connected with each other by connecting points, which is construed identically for a partial number of the technical devices, is automatically described as at least one module for the partial number of the technical devices.

8. Procedure for diagnosing at least one technical device, which comprises several units, and which is assigned to a number of technical devices, whereby the diagnosis is carried out with the aid of a model for the at least one technical device, which is described by a procedure according to claim 1.

9. Device for modeling of technical devices, whereby it is provided, that each technical device provides units, which are connected with each other over connecting points, whereby the device is construed to automatically describe at least one structure of units that are connected with each other by connecting points, which provides similarities for all technical devices, as at least one mutual module for all technical devices.

10. Computer program with program code means, in order to implement all steps of a procedure according to claim 1, if the computer program is carried out on a computer or a corresponding arithmetic unit.

11. Computer program product with program code means, which are stored on a computer-readable data carrier, in order to carry out all steps of a procedure according to claim 1, if the computer program is carried out on a computer or a corresponding arithmetic unit.
